(19) United States
(12) Patent Application Publication
(10) Pub. No.: US 2003/0113486 A1
(43) Pub. Date: Jun. 19, 2003

(54) Photographic film container

(75) Inventors: Shigekazu Sakai, Tokyo (JP); Hideo Ishii, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA CORPORATION, Tokyo (JP)

(21) Appl. No.: 10/272,090

(22) Filed: Oct. 15, 2002

(30) Foreign Application Priority Data
Oct. 23, 2001 (JP) 324754/2001
Jul. 18, 2002 (JP) 209448/2002

(51) Int. Cl. B32B 1/02

(52) U.S. Cl. 428/34.1; 206/484

(57) ABSTRACT

A photographic film container made of a metallic material comprising: a metallic support; an antirust coating comprising no hexavalent chromium on at least one side of the metallic support; and a paint coating on the antirust coating, wherein when the metallic material is subjected to the bend test of 180 degrees using a mandrel having a diameter of 2 mm in accordance with JIS-K-5600-5-1 and the bent portion of the metallic material is evaluated in accordance with JIS-K-5600-8-1, the flaking grade of the coatings of the metallic material determined by JIS-K-5600-8-5 is within 1 to 4 grade.

### TECHNICAL FIELD

The present invention relates to a photographic film container having an antirust coating containing no hexavalent chromium.

### RELATED ART

Hitherto, as a roll film, a long roll film for motion picture and its refill film, an X-ray roll film for medical use and a 135 size roll film for amateur use are well known. These films are contained in various packaging conformations as needed.

For example, in the case of the above-mentioned 135 size roll film, the 135 size film is wound onto a spool in a roll form and is packaged in a light shielding photographic film container having an exit lip for the film. Further, in order to maintain film quality, the film container is packed in a moisture resistant vessel or envelope.

In the case of a long roll film, a strip of roll film is wound onto a core to form a roll and packed in a simple light shielding package form with a light shielding material such as black polyethylene sheet or black paper, then packaged in a container. An X-ray roll film for medical use is packaged similarly.

Metal or resin is often employed as material for a photographic film container of a roll film based on demand. Metal material is superior to resin material in term of handling and recycling properties, and storage stability of photographic film.

Areas comprising conductive areas and insulated areas are arranged on film container to allow a camera to detect the kind of conventional film on an outer surface of the metallic photographic film container for 135 size roll film (hereinafter, also referred to simply as a cartridge). The areas are designated as the CAS areas i.e. Camera Auto-Sensing areas, hereinafter also referred to as CAS areas, as described in ISO1007 2000-06-01. The electrically conductive areas of the CAS areas tend to rust because the bare metallic material is exposed to the air. When rust forms on the CAS areas, a camera may incorrectly detect the information of film loaded into the camera (for example, ISO 400 film is incorrectly detected as ISO 100 film). Therefore, rust-resistant metallic material is employed.

Any thin plate metallic material which is electrically conductive and has thickness of 0.1 to 0.5 mm can be employed as a metallic material used for a cartridge featuring CAS areas. A 0.1 to 0.5 mm thick steel plate is generally employed in terms of convertibility, cost and strength.

There is usually used steel plate material for a cartridge, which is provided with a metal-plating coating to prevent rust formation in the CAS areas on the side having the CAS areas and also on the inside of a cartridge with a rust preventing coating as a primer to enhance adhesion of a paint coating to the steel plate. A steel plate material is also employed, which is provided with an antirust coating, as a primer, formed on a metal plating coating.

Metal-plated steel plate materials are commonly known, such as a tinplate, which is a cold-rolled steel plate having a tin-plated surface, and tin-free steel having a metallic chromium coating and a hydrated chromium oxide coating, as described in “Buriki to Tin-free-Steel” (Tin-plate and Tin-free Steel) edited by Toyo Kohan Co. Ltd., published by AGNE Corp.

Further, a steel plate having an antirust coating, such as a steel plate on the surface of which a hydrated chromium oxide coating is formed (chromate treatment) as an antirust coating, as described in “Kinzoku Hyomen Gijutsu Binran” (Handbook of Metal Surface Finishing Technology) edited by The Surface Finishing Society of Japan, published by THE NIKKAN KOGYO SHIMBUN, LTD., page 917, may also be employed.

The above-mentioned tin-free steel and steel plate subjected to the chromate treatment are excellent as material used for a cartridge. However, there is a drawback in that a paint coating coated onto a surface of a metallic plate is easily flaked off in the manufacturing process of cartridges. Consequently, it takes time and labor to remove flakes of flaked-off paint.

Specifically, production of a cartridge requires many complicated processes. A cartridge body, for example, is prepared by the processes of; 1) cutting a metallic material on which plural pieces of cartridge design are printed into a small plates of a size meeting a cartridge, 2) punching the small plates to the developed shapes of a cartridge, 3) bending the portion to form an exit lip for the film, 4) adhering a light shielding part, 5) rolling it to a cylinder form.

Cartridge caps to be mounted onto the top and bottom of a cartridge body are prepared by the process of 1) punching a metallic material, which is painted on both sides, into a circular plate of the cap size, 2) subjecting the periphery of the circular plate to deep-drawing to form a groove to fit the cartridge body.

After a 135 size roll film, wound onto a spool, is packaged in a cartridge body prepared as mentioned above, caps are put on both ends of the body and fitted tightly, and then a packaging of the 135 size roll film in the cartridge is completed.

Thus, since production of the cartridge is performed through a continuous line process including cutting and pressing steps, fine flakes of coatings are often produced by flaking off from coatings at each process of cutting, drawing and bending. In order to remove the flakes of coatings, it is needed to carry out careful flake and dust removing control by means of blowing air or brushing.

In cases when the flakes adhere onto a film surface before picture taking, these portions result in white spots after picture taking, leading to formation of black spots when the film is printed. When the flakes adhere onto the film surface after picture taking, the portions are not developed properly, resulting in white spots on prints and causing troubles.

The cleaning measures of the flakes of the coatings are carefully carried out in the production process to prevent occurrence of such problems. However, in the case of a cartridge, it is difficult to remove these flakes when the flakes adhere onto light shielding material such as pile and velvet, which is pasted onto the exit lip of the cartridge.

Therefore, the flakes are removed by ionized air blow over the body and caps and exhausting them from the production line, and also vacuuming the light shielding material, pasted on the exit lip for the film, in order to prevent the flakes of the coatings from adhering onto, which are further carried into the cartridge bodies and caps during cartridge preparation.

Further, the film is shipped after checking for adhesion of the flakes by random sampling at the shipping inspection station. The current process is carried out to perform 135 size roll film production with careful control of manufacturing conditions. However, the management of the control is exceedingly costly, so that the development of an easily controllable metallic material used for a photographic film container has been demanded. Further, an antirust agent containing hexavalent chromium may be employed as the antirust coating of a metallic material. However, hexavalent chromium is toxic to humans and is recognized as an allergenic when it contacts human skin. Use of hexavalent chromium is controlled from the point of view of environmental influence especially in Europe and the United States. Consequently, when the antirust agent containing hexavalent chromium is employed, there is a possibility that even invisible flakes of coatings flaking off during the production process or distribution process, to cause problems, even if occurrence of the flaking-off is not at a level of adversely affecting photographic characteristics.

### SUMMARY OF THE INVENTION

The present invention was achieved in view of the above-mentioned situation and an aspect of the present invention is to provide a photographic film container which does not require specific control for dust removal in the cartridge manufacturing process, and prevents adhesion of flaked-off fragments onto the loaded 135 size roll film, and further exhibits excellent environment suitability.

The forgoing aspect of the present invention can be accomplished by the following embodiments.

A photographic film container made of a metallic material comprising: a metallic support; an antirust coating comprising no hexavalent chromium on at least one side of the metallic support; and a paint coating on the antirust coating. Further, the metallic material has following property: when the metallic material is subjected to the bend test of 180 degrees using a mandrel having a diameter of 2 mm in accordance with JIS-K-5600-5-1 and the bent portion of the metallic material is evaluated in accordance with JIS-K-5600-8-1, the flaking grade of the coatings of the metallic material determined by JIS-K-5600-8-5 is within 1 to 4 grade.

### BRIEF DESCRIPTION OF DRAWINGS

FIG. 1(a) and FIG. 1(b) are examples of schematic views showing the coating arrangement of the metallic material used for a photographic film container of the present invention.

### DETAILED DESCRIPTION OF THE INVENTION

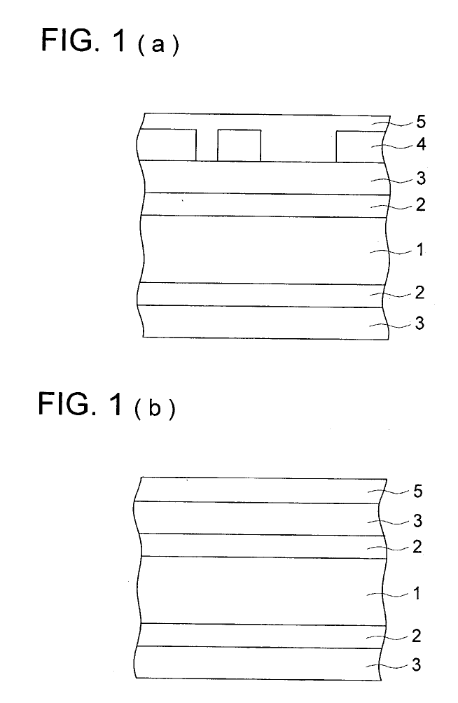

The present invention will be further detailed below. FIG. 1 is a schematic view illustrating an example of a coating arrangement of a metallic material used for a photographic film container of the present invention. FIG. 1(a) is a schematic view of an example of a coating arrangement of a metallic material used for a cartridge body. FIG. 1(b) is a schematic view of an example of a coating arrangement of a metallic material used for a cartridge cap.

In FIG. 1(a) and FIG. 1(b), “1” is a metallic support, “2” is an antirust coating provided onto metallic support 1, “3” is a paint coating provided on antirust coating 2, “4” is a printed coating provided on paint coating 3, “5” is a protective coating provided on paint coating 3 and printed coating 4. A plated coating may be provided between metallic support 1 and antirust coating 2. Further, a primer coating may be provided between antirust coating 2 and paint coating 3. Furthermore, printed coating 4 may be provided on antirust coating 2.

In the present invention, the term, “flaking” means that the coatings provided onto the metallic support are flaked from the metallic support or a coating is flaked from other coatings. Further, the flaked-off coating may be only a paint coating, only a printed coating, a paint coating together with a printed coating and a protective coating thereon, and coatings further including a antirust coating.

The antirust coating of the present invention is a coating provided on a metallic support, which contains no hexavalent chromium. The antirust coating preferably contains phosphate, molybdate, borate, silica or sulfur containing antirust agents. Further, an antirust coating can be provided on the surface of a metallic support by a chemical conversion method, in which a metallic support is immersed into treatment solution containing water, an aqueous emulsion resin and a antirust agent. It can also be provided by a coating method using a coating solution containing a polyester resin, a thermosetting agent and an antirust agent. Furthermore, a combination of a chemical conversion method and a coating method can be employed. Any of these methods may also be employed as of appropriate in accordance with demand.

Metallic support 1 used in the present invention is not specifically limited, however, examples listed below show that a thin metallic plate can be rolled from the following plate materials such as, cold-rolled steel, hot dip zincing steel, electrogalvanized steel, zinc alloy (i.e. zinc-iron, zinc-aluminum, zinc-nickel) plated steel, tin-free steel, aluminum plated steel, stainless steel, copper plated steel, tin plated steel, and thin plates of rolled metals such as copper. Of these, cold rolled steel plate is preferably employed in terms of convertibility and cost. The thickness of the metallic support is 0.1 to 0.5 mm, and preferably 0.2 to 0.3 mm in terms of convertibility and strength.

The center-line mean roughness Ra of the surface of metallic support 1 onto which antirust coating 2 is provided, is preferably 0.2 to 3.0 μm, and more preferably 0.5 to 2.0 μm. The center-line mean roughness Ra is a value measured according to JIS B 0601-1994 (corresponding to ISO 468-1982, ISO 3274-1975, ISO 4287/1-1984, ISO 4287/2-1984 and ISO 4288-1985).

Examples of preferably used phosphate antirust agents contained in antirust coating of the present invention include:

(a) metal condensed phosphate: such as condensed aluminum phosphate, or condensed zinc phosphate,

(b) metal phosphate: such as zinc phosphate, silicon phosphate, titanium phosphate, aluminum phosphate, calcium phosphate, potassium phosphate, ammonium phosphate, barium phosphate, sodium phosphate, manganese phosphate, cobalt phosphate, or zirconium phosphate,

(c) metal phosphite: such as zinc phosphite, barium phosphite, magnesium phosphite, or manganese phosphite,

(d) metal hypophosphite: such as calcium hypophosphite, or iron hypophosphite,

Examples of molybdate antirust agents preferably employed in antirust coating of the present invention include:

(a) zinc molybdate, zinc-calcium molybdate, zinc-potassium molybdate,

(b) calcium molybdate,

(c) aluminum phosphomolybdate,

Examples of preferably used borate antirust agents in antirust coating of the present invention are shown below,

(a) barium metaborate and

(b) calcium borate

Examples of preferable silica antirust agents contained in antirust coating of the present invention include:

(a) fumed silica: such as AEROSIL 130, AEROSIL 200, AEROSIL 300, AEROSIL 380, AEROSIL R972, AEROSIL R811 and AEROSIL R805, manufactured by NIPPON AEROSIL CO., LTD.,

(b) organosol of silica: such as MA-ST, IPA-ST, NBA-ST, IBA-ST, EG-ST, XBA-ST, ETC-ST and DMAC-ST, manufactured by Nissan Chemical Industries, Ltd.,

(c) precipitated silica: such as T-32, K-41 and F-80, manufactured by TOKUYAMA Corp.,

(d) gelated silica: such as Syloid244, Syloid150, Syloid72, Syloid65 and SHIELDEX, manufactured by Fuji-Davison Chemical Ltd.

A mixture of two or more of the above silicas can also be used.

Examples of preferred sulfur containing antirust agent in antirust coating of the present invention include a sulfide, triazinthiol compound, compound containing a thiocarbonyl group, thiosulfate and persulfate. Of these, triazinthiol compound and compound containing a thiocarbonyl group are specifically preferable in terms of stability.

Examples of preferably used the other antirust agent contained in antirust coating of the present invention include an iron oxide, a calcium complex and zinc-calcium cyanamide.

Methods for providing an antirust coating on a metallic support by a chemical conversion treatment are generally well known, as described in Kinzoku no Kaseishori (A Chemical Conversion Treatment of Metal), published by Riko Shuppan Corp. Further, there are also applicable methods described in Japanese Patent Publication Open to Public Inspection (hereinafter, referred to as JP-A) Nos. 5-195245, 5-230669, 5-287589, 5-306497, 6-2157, 8-20876, 8-302477, 9-209166, 9-217180, 9-228064, 10-140366, 10-237667, 2000-226673, 2001-49451, 2001-152356 and 2001-164389.

The thickness of the antirust coating coated by a chemical conversion treatment is not specifically limited, but preferably is 0.01 to 3.00 μm, and more preferably 0.05 to 1.00 μm. The coverage of the antirust agent is preferably 1 to 100 mg/m², and is more preferably 10 to 50 mg/m². Sufficient antirust effect cannot be attained at a coverage of less than 1 mg/m², allowing to form rust on the metallic support, and often causing flaking of the coating when bent. A coverage exceeding 100 mg/m² results in excessively increased antirust agent in the coating, causing flaking-off of the coating when bent, and leading to decreased convertibility.

Examples of a method to provide antirust coating by a coating method include common methods known in the art, such as, roll-coating, spray coating, brush coating, electrostatic coating, dip coating, electrodeposition coating, curtain coating and a roller coating method.

The thickness of antirust coating formed by a coating method is not limited, but is preferably 0.1 to 20.0 μm, and more preferably 1.0 to 8.0 μm. The coverage of antirust agent is preferably 500 to 2000 mg/m², and is more preferably 1000 to 1800 mg/m². Sufficient antirust effect cannot be obtained with less than 500 mg/m², and if rust forms on the metallic support, then the coating may flake when bent. While when exceeding 2000 mg/m², pigment content in the paint coating is excessive, and convertibility may deteriorate as the coating flakes off when bent.

The drying condition of antirust coating can be set properly based on the resin to be used. When the coating is coated by a coil-coating method and continuously subjected to burning, the maximum temperature which the material reaches is preferably 60 to 300° C., and burning at 180 to 250° C. over a period of 15 to 60 seconds is specifically preferred. Batch type burning can be conducted at temperature of 80 to 140° C. over a period of 10 to 30 seconds.

The resin used for paint is not specifically limited, however, the following examples as described in Kothinguyo Jushi Gijutsu (Technology of Resin for Coating) published by Kogyo Chousa kai Ltd. are preferable, such as, rosin, ester gum, penta resin, cumarone.indene resin, phenol resin, modified phenol resin, maleic resin, alkyd resin, amino resin, vinyl resin, petroleum resin, epoxy resin, polyester resin, polystyrene resin, acrylic resin, silicone resin, gum-base resin, chlorinated resin, urethane resin, polyamide resin, polyimide resin and fluoro-resin. Further, components as described in JP-A Nos. 2000-129203, 5-208166 and 7-148461 may also be effectively used.

Of these, specifically preferable resins include an epoxy resin and a polyester resin. Further, of polyester resins, a hydroxyl group containing polyester resin is preferable in terms of convertibility, chemical resistance and coatability of the coating. Coating of epoxy resin or polyester resin can be hardened by adding at least one curing agent selected from amino resins and blocked polyisocyanate compounds, followed by heat curing.

Examples of solutions used for the chemical conversion treatment of the present invention include, for example, CT-E301, CT-E200, CT-E254 and CT-E220 manufactured by NIHON PARKERIZING CO., LTD. Further, the paint and the primer used in the present invention include, for example, KP-8100 and KP-8110 manufactured by KANSAI PAINT CO., LTD. and N-56-255 manufactured by KAWAKAMI PAINT MFG. CO., LTD.

On the outer surface of the cartridge of the metallic material used for a photographic film container of the present invention, can be provided a printed coating applied onto the antirust coating or the paint coating except on the electrically conductive portion of the CAS areas. Further, a protective coating can also be provided onto the paint coating and the printed coating.

Commonly known inks, paints and varnishes for a metallic material can be employed for the printed coating and the paint coating. Examples of the ink and the paint are described in JP-A Nos. 60-26061, 60-26062, 60-26063, 61-233738, 63-44653, 62-125348 and 9-269566. Specific examples of the paint and ink include paints and inks of an alkyd resin type, an ami.alkyd resin type, a polyester resin type, various antirust paints, water-based paints and cellulose derivatives.

The metallic material for use in the photographic film container of the present invention preferably exhibits the following properties described below. The above-mentioned metallic material is subjected to a bend test of 180 degrees using a 2 mm diameter mandrel according to JIS K 5600-5-1-1999, which standard corresponds to ISO 1519:1973, Paints and Varnishes-Bend test (cylindrical mandrel). Further, the quantity of coating flakes produced from the antirust coating on the metallic support and the paint coating or the printed coating on the antirust coating at the bent portion is evaluated based on JIS K 5600-8-1-1999, which standard corresponds to ISO 4628-1:1982, Paints and vanishes—Evaluation of degradation of paint coatings—Designation of intensity, quantity and size of defect—Part 1: General principles and rating schemes. Furthermore, the metallic material of the invention exhibits the results of grades 1 to 4 with respect to flaking, based on quantity of coating flakes, as defined in JIS K 5600-8-5, which standard corresponds to ISO 4628-5:1982, Paints and vanishes—Evaluation of degradation of paint coatings—Designation of intensity, quantity and size of defect—Part 5: Designation of degree of flaking. A level exceeding grade 4 possibly produces problems that coating flakes adhere onto a photographic film, causing troubles.

Techniques to prepare the cartridge using the metallic material for use in a photographic film container of the present invention is well known in the art, and as described in Kinzoku Binran kaitei 5han (Handbook of Metals 5th edition) edited by The Japan Institute of Metals, published by MARUZEN CO., LTD. and in Puresu-kako Binran (Handbook of Press Working) edited by The Japan Society for Technology of Plasticity, published by MARUZEN CO., LTD.

For example, when preparing the body of the cartridge, a large metallic plate printed with plural designs of a cartridge, is cut into small pieces of cartridge size. Then, the cartridge size piece is die punched to form a cartridge shape. This die punching technology is well known in the art and described in Puresu-kako Binran (Handbook of Press Working) edited by The Japan Society for Technology of Plasticity, published by MARUZEN CO., LTD., page 89 to 144 Sendankako (Shearing).

Also, the preparation of the cap is similarly performed by generally known technology and described in Puresu-kako Binran (Handbook of Press Working) edited by The Japan Society for Technology of Plasticity, published from MARUZEN CO., LTD. p299 Puresuseikeikako (Press mold working) and p759 Kakoki oyobi Kata (Working machines and Dies).

The technology to adhere a light shielding part onto the above-mentioned small plate is described in JP-A Nos. 63-85625 and 63-85626, and Japanese Patent (Registered) No. 2829764.

The technology to make the material adhered with a light shielding part to a cylindrical cartridge body is commonly known in the art as described in Kinzoku Binran kaitei 5han (Handbook of Metals, 5th edition) edited by The Japan Institute of Metals, published by MARUZEN CO., LTD. and in Puresu-kako Binran (Handbook of Press Working) edited by The Japan Society for Technology of Plasticity, published by MARUZEN CO., LTD.

The technology to load a film into the body and to fit caps onto the body can be employed as described in Japanese Utility Model Open to Public Inspection (hereinafter, referred to as JU-A) Nos. 63-29136 and 1-140539, JP-A Nos. 1-287670 and 60-6502. Also, a combination of these technologies can be employed as described in JP-A Nos. 60-26061, 60-26062 and 60-26063.

Piled fabric can be employed as the light shielding material pasted at the exit lip for film of the cartridge and is commonly known. Examples thereof include, a weave structured light shielding material described in JU-A Nos. 62-51341, 62-167249, 4-18846, 4-18844 and 4-28641, and JP-A Nos. 4-73642, a raising method light shielding material described in JP-A Nos. 7-152114 and 9-120116, and a woven method light shielding material described in JP-A Nos. 62-125346, 62-65036, 62-201432, 62-201432, 62-98374, 2-15254 and 2000-29175.

Further, a method to paste the light shielding material onto the cartridge is also employed using an apparatus and an adhesive which are common knowledge in the art. For example, an apparatus can be employed as described in JP-A Nos. 63-74869 and 4-22944, and JU-A 63-74638, and a polyester-type hot-melt adhesive described in JP-A Nos. 8-41439 and 4-19738, as well as an olefin-type hot-melt adhesive described in JP-A Nos. 61-289347 and 63-49756.

### EXAMPLES

The present invention will be further described based on the following examples, but the present invention is not limited by these examples.

### Example 1

<Preparation of a Rust-Proofed Steel Plate for Use in a Cartridge Body>

A rust-proofed steel plate 101 having a antirust coating was prepared by the steps of: (1) preparing as a metallic support a 0.25 mm steel plate at a surface roughness of Ra 1.0 μm, manufactured by a cold rolled method, (2) preparing a coating solution containing strontium chromate as an antirust agent, polyester resin, a thermosetting agent and petroleum naphtha with sufficient stirring, (3) coating the above coating solution onto both sides of the steel plate using a roller coating. Further, the coating amount was adjusted to obtain coverage of strontium chromate of 1500 mg/m² per one side.

After that, rust-proofed steel plates 102 through 115 having a antirust coating were prepared in the same way as for steel plate 101 except that the antirust agent and their coverage were changed as shown in Table 1.

<Preparation of Paint Coated Steel Plate for Use in a Cartridge Body>

After a 15 μm coating of a light shielding black paint was applied onto one side of rust-proofed steel plates 101 through 115, a 5 μm coating of a white paint was applied as a subbing paint coating onto the other side of the steel plates. Further, an appropriate design was printed onto the above paint coating to form a printed coating, and finally, a protective coating was provided by printing. The thus coated steel plates for use in a cartridge body having a coating arrangement shown in FIG. 1(a) were prepared, and samples were designated as Samples 101 through 115.

<Coating Condition of Light Shielding Black Paint>

An acrylic paint containing carbon black was coated as a black paint using a roller coat method, and dried at 170° C. for 10 minutes.

<Coating Condition of White Paint for Subbing>

An acrylic paint containing titanium oxide was coated using a roller coat method, and dried at 170° C. for 10 minutes.

<Printing Condition>

Printing was performed using an acrylic paint as an ink using a gravure printing method, and a protective coating was printed using a polyester.amino resin type transparent varnish as a varnish coating again using a gravure printing method.

<Measurements of Flaking Grades>

Each of Samples 101 through 115 was subjected to a bend test of 180 degrees as a flaking test based on JIS K 5600-5-1:1999, and was evaluated according to JIS K 5600-8-1:1999, and flaking was graded according to JIS K 5600-8-5:1999 and the results thereof are shown in Table 1. The test was carried out using 2 mm diameter mandrel.

<Evaluation of Performance>

(Preparation of Samples)

Samples 101 through 115 were each pressed to a capped configuration. The cartridge was prepared using said caps and each steel plate of Samples 101 through 115, and then a film, CENTURIA SUPER 400 was packaged therein.

(Test Method)

Picture taking (a typical camera exposure) was performed after loading the above-mentioned cartridge including film into a camera. After camera exposure the film was processed under usual development and printed. The thus obtained print was observed visually with respect to the presence of white or black spots.

(Evaluation Criteria)

1: no white and black spots were observed

2: insignificant white and black spots could be observed upon close inspection but could not be recognized at the distance of more than 30 cm

3: white and black spots could be recognized at a distance of 30 cm

4: white and black spots could be recognized at a distance of 1 m

TABLE 1

| Sample | Antirust | Coverage | Grade of | Presence | |
|---|---|---|---|---|---|
| No. | Agent | (mg/m²) | Flaking | of spots | Remarks |
| 101 | strontium | 1500.0 | 5 | 3 | Comp. |
| | chromate | | | | |
| 102 | calcium | 1500.0 | 5 | 4 | Comp. |
| | chromate | | | | |
| 103 | zinc | 1500.0 | 1 | 1 | Inv. |
| | phosphate | | | | |
| 104 | aluminum | 100.0 | 4 | 1 | Inv. |
| | phosphate | | | | |
| 105 | aluminum | 500.0 | 3 | 1 | Inv. |
| | phosphate | | | | |
| 106 | aluminum | 700.0 | 2 | 1 | Inv. |
| | phosphate | | | | |
| 107 | aluminum | 1000.0 | 1 | 1 | Inv. |
| | phosphate | | | | |
| 108 | aluminum | 1500.0 | 1 | 1 | Inv. |
| | phosphate | | | | |
| 109 | aluminum | 1800.0 | 1 | 1 | Inv. |
| | phosphate | | | | |
| 110 | aluminum | 1900.0 | 2 | 1 | Inv. |
| | phosphate | | | | |
| 111 | aluminum | 2000.0 | 3 | 1 | Inv. |
| | phosphate | | | | |
| 112 | aluminum | 2200.0 | 4 | 1 | Inv. |
| | phosphate | | | | |
| 113 | barium | 1500.0 | 1 | 1 | Inv. |
| | metaborate | | | | |
| 114 | zinc | 1600.0 | 1 | 1 | Inv. |
| | molybdate | | | | |
| 115 | Silica | 1800.0 | 1 | 1 | Inv. |

Comp.: Comparative Sample
Inv.: Inventive Sample

Sample 101 and 102 using conventional antirust agents had a flaking grade exceeding 4 of the coated surface, and, Samples 103 through 115 using antirust agents of the present invention had flaking grade of the coated surface within the range of grades 1 through 4. As is apparent from the above Table 1, each of the inventive film cartridges showed property superior to the comparative samples.

### Example 2

<Preparation of Rust-Proofed Steel Plate for Use in a Cartridge Cap>

Rust-proofed steel plate 201 having a antirust coating was prepared by the process of: (1) preparing as a metallic support was 0.22 mm steel plate at a surface roughness of Ra 1.5 μm, manufactured by a cold rolled method, (2) preparing a coating solution containing zinc chromate as a antirust agent, water and an aqueous emulsion resin, (3) coating the above coating solution onto both sides of the above steel plate by a dip coating method. Further, the coating amount was adjusted to obtain 30.0 mg/m² coverage of zinc chromate.

Then, rust-proofed steel plates 202 through 215 having a antirust coating were prepared in the same way as in steel plate 201 except that the antirust agent and its coverage were changed as shown in Table 2.

<Preparation of Coated Steel Plate Used for Cartridge Cap>

A light shielding black paint used in Example 1 was coated to 10 μm as a paint coating onto both sides of each rust-proofed steel plates 201 through 215, a protective coating was provided by a roller coating method, and dried at 170° C. for 10 minutes. The coated steel plates used for a cartridge cap having a coating arrangement shown in FIG. 1(b) were prepared to obtain Samples 201 through 215.

<Measurements of Flaking Grades and Evaluation of Performance>

Each of Samples 201 through 215 was subjected to the measurement of flaking and evaluation of the performance in the same manner as in Example 1, and the results were shown in Table 2.

TABLE 2

| Sample | Antirust | Coverage | Grade of | Presence | |
|---|---|---|---|---|---|
| No. | Agent | (mg/m²) | Flaking | of spots | Remarks |
| 201 | zinc | 30.0 | 5 | 3 | Comp. |
| | chromate | | | | |
| 202 | potassium | 30.0 | 5 | 4 | Comp. |
| | chromate | | | | |
| 203 | zinc | 15.0 | 1 | 1 | Inv. |
| | phosphite | | | | |
| 204 | calcium | 0.6 | 4 | 1 | Inv. |
| | phosphate | | | | |
| 205 | calcium | 1.0 | 3 | 1 | Inv. |
| | phosphate | | | | |
| 206 | calcium | 5.0 | 2 | 1 | Inv. |
| | phosphate | | | | |
| 207 | calcium | 10.0 | 1 | 1 | Inv. |
| | phosphate | | | | |
| 208 | calcium | 25.0 | 1 | 1 | Inv. |
| | phosphate | | | | |
| 209 | calcium | 50.0 | 1 | 1 | Inv. |
| | phosphate | | | | |
| 210 | calcium | 80.0 | 2 | 1 | Inv. |
| | phosphate | | | | |
| 211 | calcium | 100.0 | 3 | 1 | Inv. |
| | phosphate | | | | |
| 212 | calcium | 110.0 | 4 | 1 | Inv. |
| | phosphate | | | | |
| 213 | calcium | 50.0 | 1 | 1 | Inv. |
| | borate | | | | |
| 214 | calcium | 40.0 | 1 | 1 | Inv. |
| | molybdate | | | | |
| 215 | Silica | 30.0 | 1 | 1 | Inv. |

Comp.: Comparative Sample
Inv.: Inventive Sample

Sample 201 and 202 using conventional antirust agents had a flaking grade exceeding 4 of the coated surface, and, Samples 203 through 215 using antirust agents of the present invention had flaking grade of the coated surface within the range of grades 1 through 4. As is apparent from the above Table 2, each of the inventive film cartridges showed property superior to the comparative samples.

### Example 3

<Preparation of Rust-Proofed Steel Plate for Use in a Cartridge Cap>

Rust-proofed steel plate 301, having a antirust coating was prepared as follows: (1) preparing as a metallic support a 0.23 mm steel plate at a surface roughness of Ra 0.8 μm, manufactured by a cold rolled method, (2) preparing a coating solution containing strontium chromate as an antirust agent and water, (3) coating the coating solution onto both sides of the steel plate using a roller coating method. Further, the coating amount was adjusted to obtain 70.0 mg/m² coverage of strontium chromate.

And then, the rust-proofed steel plates 302 through 315, having a antirust coating, were prepared in the same way as for steel plate 301 except that the antirust agent and its coverage were changed as shown in Table 3.

<Preparation of Coated Steel Plate for Use in Cartridge Cap>

A primer coating solution containing polyester resin having a hydroxyl group, an amino resin and silica as an antirust agent was coated at a thickness of 5 μm onto both sides of each of rust-proofed steel plates 301 through 315 by a roller coating method, after while the coated plates were dried at 200° C. for 1 minute. A primer coating was provided onto each plate. Further, the black paint as same black paint as used in Example 1 was coated on the primer coating adjusting to thickness of 10 μm, and dried at 220° C. for 1 minute. The coated steel plate for use in a cartridge cap having a coating arrangement as shown in FIG. 1(b) was prepared, and samples were designated as Samples 301 through 315.

<Measurements of Flaking Grades and Evaluation of Performance>

Each of Samples 301 through 315 was subjected to the measurement of flaking and evaluation of the performance in the same manner as in Example 1, and the results were shown in Table 3.

TABLE 3

| Sample | Antirust | Coverage | Grade of | Presence | |
|---|---|---|---|---|---|
| No. | Agent | (mg/m²) | Flaking | of spots | Remarks |
| 301 | strontium | 70.0 | 5 | 3 | Comp. |
| | chromate | | | | |
| 302 | calcium | 70.0 | 5 | 4 | Comp. |
| | chromate | | | | |
| 303 | zinc | 15.0 | 1 | 1 | Inv. |
| | phosphate | | | | |
| 304 | Silica | 0.6 | 4 | 1 | Inv. |
| 305 | Silica | 1.0 | 3 | 1 | Inv. |
| 306 | Silica | 5.0 | 1 | 1 | Inv. |
| 307 | Silica | 10.0 | 1 | 1 | Inv. |
| 308 | Silica | 40.0 | 1 | 1 | Inv. |
| 309 | Silica | 80.0 | 1 | 1 | Inv. |
| 310 | Silica | 100.0 | 5 | 1 | Inv. |
| 311 | Silica | 150.0 | 3 | 1 | Inv. |
| 312 | aluminum | 120.0 | 4 | 1 | Inv. |
| | phosphate | | | | |
| 313 | zinc | 50.0 | 1 | 1 | Inv. |
| | molybdate | | | | |
| 314 | zinc | 40.0 | 1 | 1 | Inv. |
| | phosphite | | | | |
| 315 | aluminum | 30.0 | 1 | 1 | Inv. |
| | phosphate | | | | |

Comp.: Comparative Sample
Inv.: Inventive Sample

Sample 301 and 302 using conventional antirust agents had a flaking grade exceeding 4 of the coated surface, and, Samples 303 through 315 using antirust agents of the present invention had flaking grade of the coated surface within the range of grades 1 through 4. As is apparent from the above Table 2, each of the inventive film cartridges showed property superior to the comparative samples.

[Effect of the Present Invention]

According to the present invention, it is possible to provide a metallic material used for a photographic film container and a cartridge prepared by use thereof, in which a specific dust removal steps in the cartridge manufacturing process is not required, causing no adhesion of the flakes to 135 mm size roll film loaded in it, and thereby making easier control at the shipping inspection and the manufacturing process.

What is claimed is:

1. A photographic film container made of a metallic material comprising:
a metallic support;
an antirust coating comprising no hexavalent chromium on at least one side of the metallic support; and
a paint coating on the antirust coating,
wherein when the metallic material is subjected to the bend test of 180 degrees using a mandrel having a diameter of 2 mm in accordance with JIS-K-5600-5-1 and the bent portion of the metallic material is evaluated in accordance with JIS-K-5600-8-1, the flaking grade of the coatings of the metallic material determined by JIS-K-5600-8-5 is within 1 to 4 grade.

2. The photographic film container of claim 1, wherein the antirust coating comprises an antirust agent selected from the group consisting of a phosphate antirust agent, a molybdate antirust agent, a borate antirust agent a sulfur containing antirust agent and a silica antirust agent.

3. The photographic film container of claim 2, wherein the antirust coating comprises a phosphate antirust agent.

4. The photographic film container of claim 2, wherein the antirust coating comprises a molybdate antirust agent.

5. The photographic film container of claim 2, wherein the antirust coating comprises a borate antirust agent.

6. The photographic film container of claim 2, wherein the antirust coating comprises a silica antirust agent.

7. The photographic film container of claim 2, wherein the antirust coating comprises a sulfur containing antirust agent.

8. The photographic film container of claim 2, wherein the antirust coating comprises at least two of the antirust agent.

9. The photographic film container of claim 1, wherein the antirust coating is provided by a chemical conversion method.

10. The photographic film container of claim 1, wherein the antirust coating is provided by a coating method.

11. The photographic film container of claim 1, wherein the side having the antirust coating of the metallic support has a center-line mean roughness determined in accordance with JIS-B-0601 of 0.2 to 3.0 μm.

12. The photographic film container of claim 1, wherein the metallic material further comprises a color coating containing ink and a protective coating on the paint coating.
